(19) United States
(12) Patent Application Publication
(10) Pub. No.: US 2011/0068598 A1
(43) Pub. Date: Mar. 24, 2011

(54) SLIDING CONSOLE WITH LOCK ASSEMBLY

(75) Inventor: Benjamin Warren Penner, Ann Arbor, MI (US)

(73) Assignee: Toyota Motor Engineering & Manufacturing North America, Inc., Erlanger, KY (US)

(21) Appl. No.: 12/564,108

(22) Filed: Sep. 22, 2009

(51) Int. Cl. B60R 7/04; E05B 65/46

(52) U.S. Cl. 296/37.8; 70/85

(57) ABSTRACT

The sliding console assembly includes a lock assembly housing, a lock assembly, and a slidable storage compartment. The lock assembly housing is configured to house and guide the movement of a lock assembly. The lock assembly housing is fixedly mounted to the slidable storage compartment. The lock assembly has a plate slidable within the lock assembly housing between a first position and a second position. The plate also includes a pair of operative surfaces. The operative surfaces are spaced apart from each other, and are generally symmetrical to the other. The operative surfaces are disposed at an angle relative to the rails. The lock assembly also includes a pair of retainers and a first biasing member. A cable is attached to a pair of handles on one end and the plate on the other end. The handles actuate the lock assembly and disengage the lock assembly from the rails.

### BACKGROUND OF THE INVENTION

1. Field of the Invention

The present invention relates generally to a sliding console assembly for use in an automotive vehicle. More specifically, the present invention relates generally to a sliding console assembly having a lock assembly operable to engage and disengage the console assembly from a rail system so as to selectively position the console assembly between a forward and a rear position.

2. Description of the Prior Art

Sliding console assemblies are currently known and used in the art. Console assemblies are generally secured to the floor of the vehicle and are often found disposed between the driver and front passenger seats. Thus, the size and dimensions of the console assembly are often dictated by the space available between the driver and front passenger seats.

Current sliding console assemblies may include a lock assembly having a retainer. The retainer is configured to engage a rail system. Such sliding console assemblies include a storage bin for containing articles such as maps, and a handle operable to actuate the lock assembly. The lock assembly is operatively connected to the retainer so as to engage and disengage the console assembly from a rail system. Thus, the storage space of current console assemblies are limited by the packaging space required to house the lock assembly.

Current lock assemblies utilize components such as levers, cams, and pawls to actuate the retainer between an engaged and disengaged position. Such components are operatively connected to each other, and each component must be fixed relative to the other component so as to ensure that the action between the components remains consistent. Maintaining the position of these components in a fixed relationship helps ensure that the retainer is operable to engage and disengage the rail. Current lock assembly configurations may become inoperable over time as the action of one component may cause another to become displaced. Furthermore, the components are typically made of a durable and dense material such as steel because the components are constantly placing a load upon each other in order to actuate the retainer.

Accordingly, it remains desirable to have a sliding console assembly that reduces the packaging space required to house the locking assembly. It also remains desirable to have a locking assembly that reduces the use of heavy materials such as steel so as to reduce the cost and weight of the vehicle thereby increasing fuel efficiency and decreasing production costs. Furthermore, it remains desirable to have a lock assembly wherein the components may remain in an operative relationship with each other so as to prolong the life of the lock assembly.

### SUMMARY OF THE INVENTION AND ADVANTAGES

The present invention provides for a sliding console assembly maximizing storage space by minimizing the packaging requirements of the lock assembly. Additionally, the present invention minimizes the use of dense materials such as steel while maintaining a long operational life by housing the lock assembly components under one housing so as to maintain the components in an operative relationship with each other.

The sliding console assembly includes a base mounted to the vehicle floor. The base includes a pair of rails. Each of the pair of rails is spaced apart and generally parallel to the other. The base and the pair of rails extend along a first longitudinal axis.

The sliding console assembly includes a bin for storing articles. The bin includes a pair of opposing side walls, and a front wall opposite a rear wall. The bin is fixedly mounted to the base. The console assembly further includes a slidable storage compartment. The slidable storage compartment may be slid in and out of the bin. The console assembly further includes a pair of handles and a cable. The pair of handles is mounted on the slidable storage compartment, and one of the pair of handles is spaced apart from the other. The cable has a first split end and a second split end. Each end of the first split end of the cable is operatively connected to a corresponding handle so as to connect both handles to the first split end of the cable.

The console assembly also includes a lock assembly housing. The lock assembly housing has an inner wall surface. The lock assembly housing is fixedly mounted to the slidable storage compartment and disposed between the pair of rails. The lock assembly housing is configured to house a lock assembly.

The lock assembly is disposed within the lock assembly housing. The lock assembly has a plate slidably disposed within the lock assembly housing. Each end of the second split end is attached to the plate. The handles are individually operable to slide the plate within the lock assembly housing between a first position and a second position. The plate is in sliding engagement with a portion of the inner wall surface of the lock assembly housing and is slidable along a second longitudinal axis. In one embodiment, the second longitudinal axis is generally normal to the first longitudinal axis. The plate also includes a pair of operative surfaces. The operative surfaces are spaced apart from each other, and are generally symmetrical to the other. The operative surfaces are disposed at an angle relative to the first axis.

The lock assembly also includes a pair of retainers and a first biasing member. The retainers are slidably disposed within the lock assembly housing along a third longitudinal axis. The lock assembly housing is configured to control the movement of the retainers along the third longitudinal axis. The third longitudinal axis is generally normal to both the first and second longitudinal axis. Each of the pair of retainers includes a pin configured to slidably engaged the operative surface. Each pin is fixedly attached to a respective retainer. Each pin is operatively engaged with a corresponding operative surface of the plate. Thus, the retainers may slide along the plate so as to move between an engaged and disengage position.

The first biasing member is operatively connected to the plate. More specifically, the first biasing member is disposed between the plate and the inner wall surface of the lock assembly housing so as to urge the plate into the first position. In the first position, the pins of both of the pair of retainers are urged to a first end of the corresponding pair of operative surfaces. As the pins are moved to the first end of the operative surface, each of the pair of retainers are displace away from each other into engagement with the pair of rails. Actuation of either of the pair of handles overcomes the force of the first biasing member so as to urge the plate into the second position. In the second position, the pins of both of the pair of retainers are moved to the second end of the operative surfaces so as to displace the pair of retainers closer towards each other wherein the retainers are disengaged from the pair of rails.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a view of an embodiment of the sliding console assembly of the present invention wherein the console assembly is in the rear position;

FIG. 2 is a view of FIG. 1 wherein the console assembly is in the forward position;

FIG. 3 is of the rail system of the sliding console assembly;

FIG. 4 is a view of the base, lock assembly housing, and the bin, wherein the console assemble has one cable;

FIG. 4a is an isolated view of the pair of cables attached to the pair of handles and the plate;

FIG. 5 is an exploded view of the lock assembly housing, and the lock assembly;

FIG. 6 is a view of the lock assembly in the first position wherein the retainers are displaced away from each other so as to engage the rails;

FIG. 7 is a view of the lock assembly in the second position wherein the retainers are displaced closer to each other with respect to FIG. 6 so as to disengage the rails;

FIG. 8 is a view of the base, lock assembly housing, and the bin, wherein the console assemble has a pair of cables;

FIG. 9 is an exploded view of the base showing the carriage, and the lock assembly housing; and

FIG. 10 is a view of the sliding console assembly wherein the entire console assembly is slidable along the rail system.

### DETAILED DESCRIPTION OF THE INVENTION

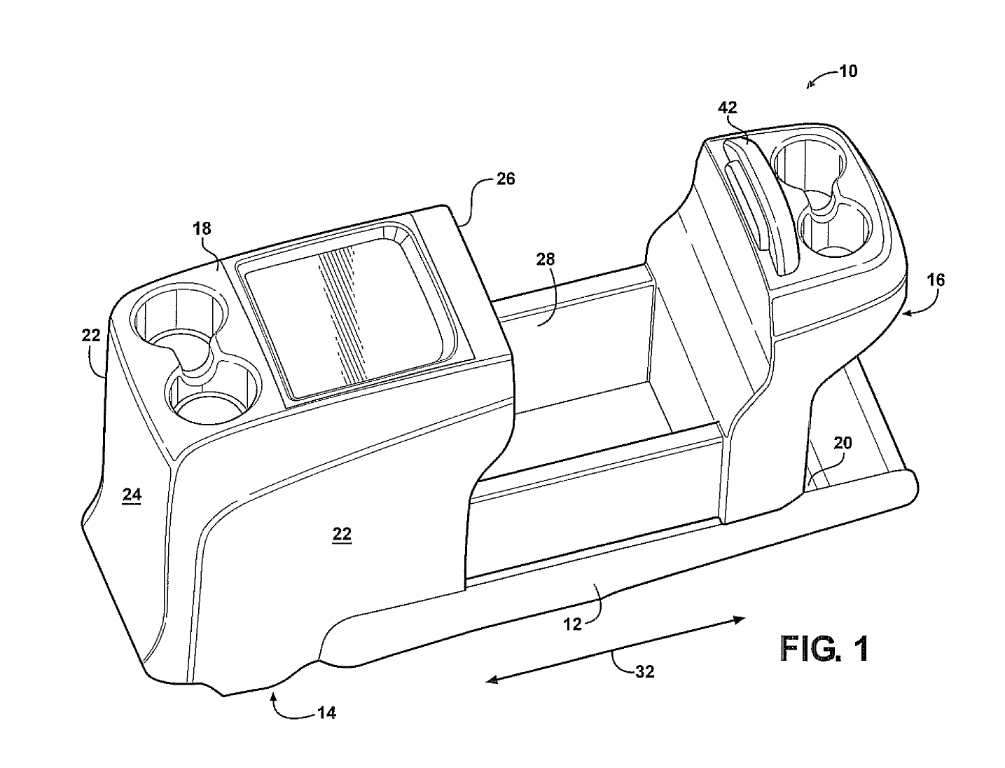

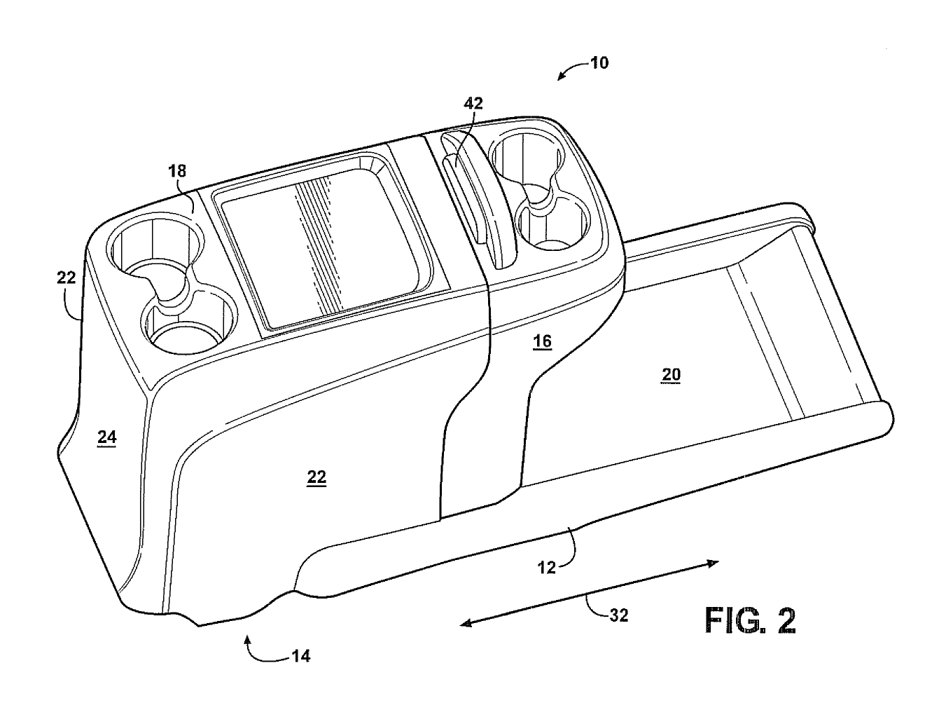

Referring to the Figures, wherein like numerals indicate corresponding parts throughout the several views, a sliding console assembly 10 for use in an automotive vehicle (not shown) is provided. With reference specifically to FIGS. 1 and 2, the console assembly 10 is mounted to the base 12. The base 12 may be mounted to the floor of an automotive vehicle. The console assembly 10 may also include a bin 14 fixedly mounted to the base 12, and a slidable storage compartment 16. The bin 14 further includes a top wall 18 opposite a bottom wall 20, a pair of opposing side walls 22, and a front wall 24 opposite a rear wall 26. The top and bottom walls 18, 20 extend between the opposing side walls 22, and the front and rear walls 24, 26 extend between both the pair of opposing side walls 22 and the top and bottom walls 18, 20. The top wall 18 may be configured to receive articles. FIGS. 1 and 2 show one portion of the top wall 18 is configured to receive two beverage containers, and another portion of the top wall 18 is shaped into a tray. However, it is anticipated that the top wall 18 may be configured in other ways currently known in the art. The bin 14 further includes an opening 28 disposed on the rear wall 26, and a storage compartment 16. Though it is anticipated that the opening 28 may be disposed on front wall 24 or both the front and rear walls 24, 26. The opening 28 of the bin 14 is configured to slidingly receive the slidable storage compartment 16.

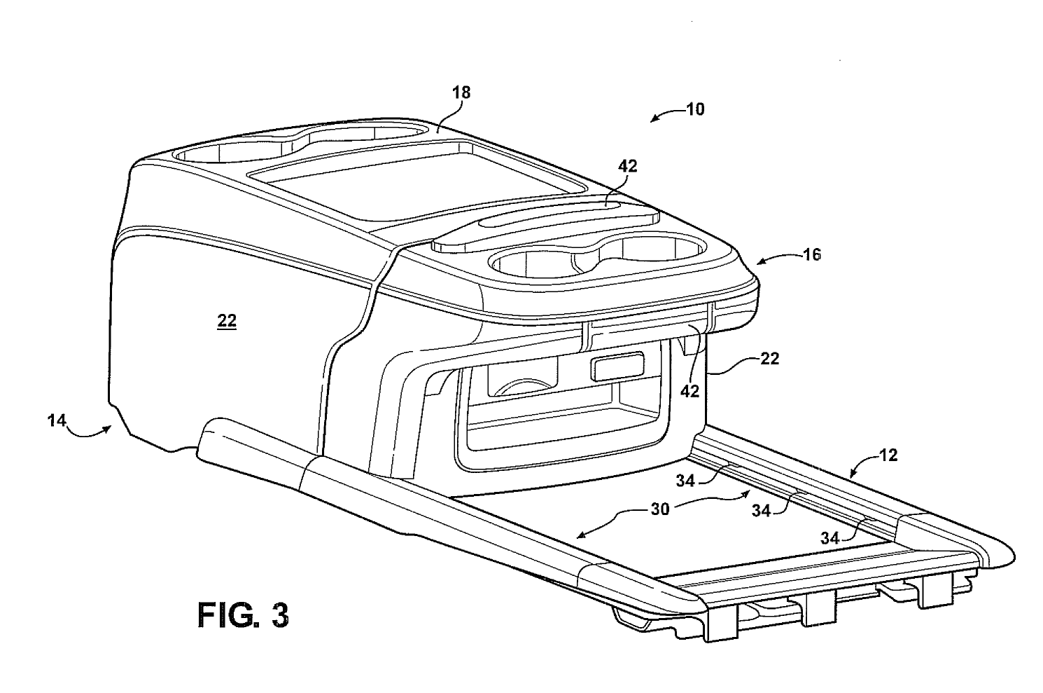

The base 12 has a pair of rails 30. Each of the pair of rails 30 is spaced apart and parallel to the other. The base 12 and the pair of rails 30 extend along a first longitudinal axis 32. The slidable storage compartment 16 is slidable between a front and rear position. With reference again to FIG. 1, the slidable storage compartment 16 is shown in the rear position, wherein a portion of the slidable storage compartment 16 is slid away from the opening 28 of the bin 14. Thus the slidable storage compartment 16 is accessible and ready for receiving articles for storage. With reference to FIGS. 2 and 3, the slidable storage compartment 16 is shown in the forward position, wherein the slidable storage compartment 16 is substantially housed within the bin 14. Thus articles placed within the slidable storage compartment 16 are secured within the bin 14 of the console assembly 10.

With reference again to FIG. 3, the base 12 is shown having the pair of rails 30 integrally formed to the base 12. The base 12 is configured to mount onto the floor of an automotive vehicle (not shown). The rails 30 may include a plurality of rail slots 34. Each of the rail slots 34 is evenly spaced apart from the other and disposed each of the rails 30 in the first longitudinal axis 32. Preferably, each of the rail slots 34 of one rail 30 is spaced apart and opposite a corresponding rail slot 34 of the other rail 30. Thus each of the rail slots 34 from one of the rails 30 is axially aligned to an opposing rail slot 34 from the other of the rails 30.

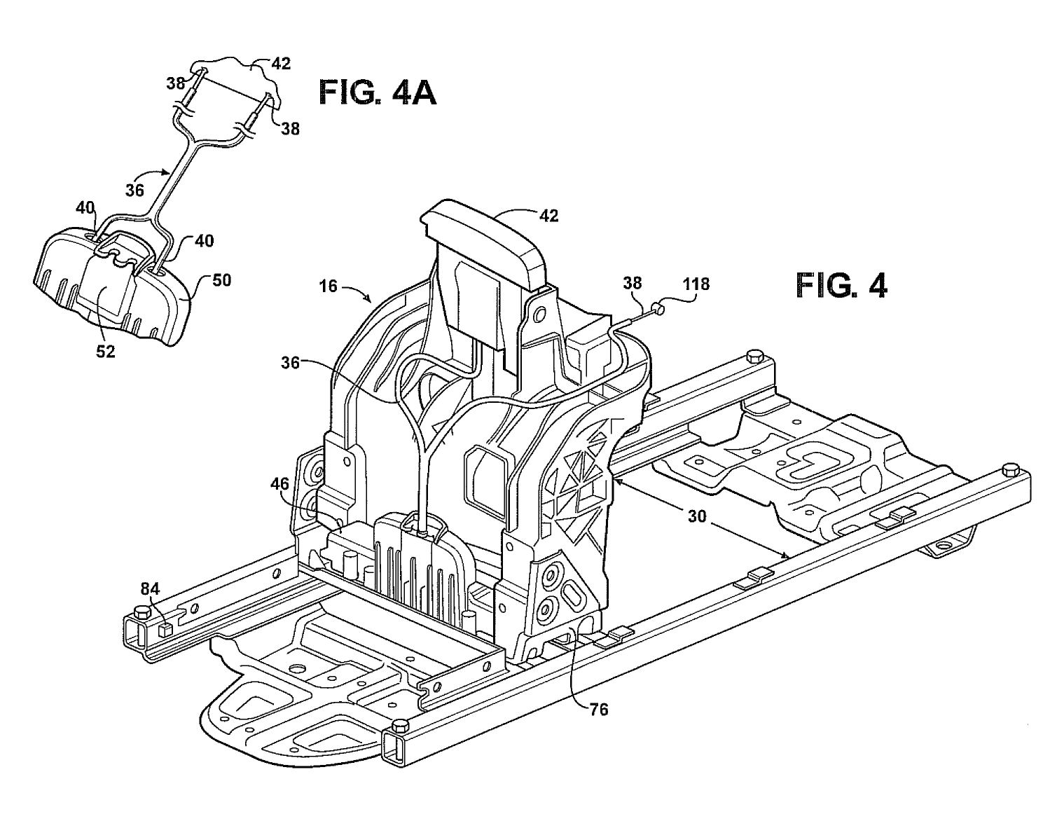

With reference now to FIGS. 4 and 4a, the console assembly 10 further includes a cable 36. The cable 36 includes a first split end 38 and a second split end 40. Each end of the first split end 38 of the cable 36 is operatively connected to a corresponding handle 42 of the pair of handles 42. The other ends of the second split ends 40 are operatively connected to the lock assembly 44 so as to engage and disengaged the bin 14 from the rails 30.

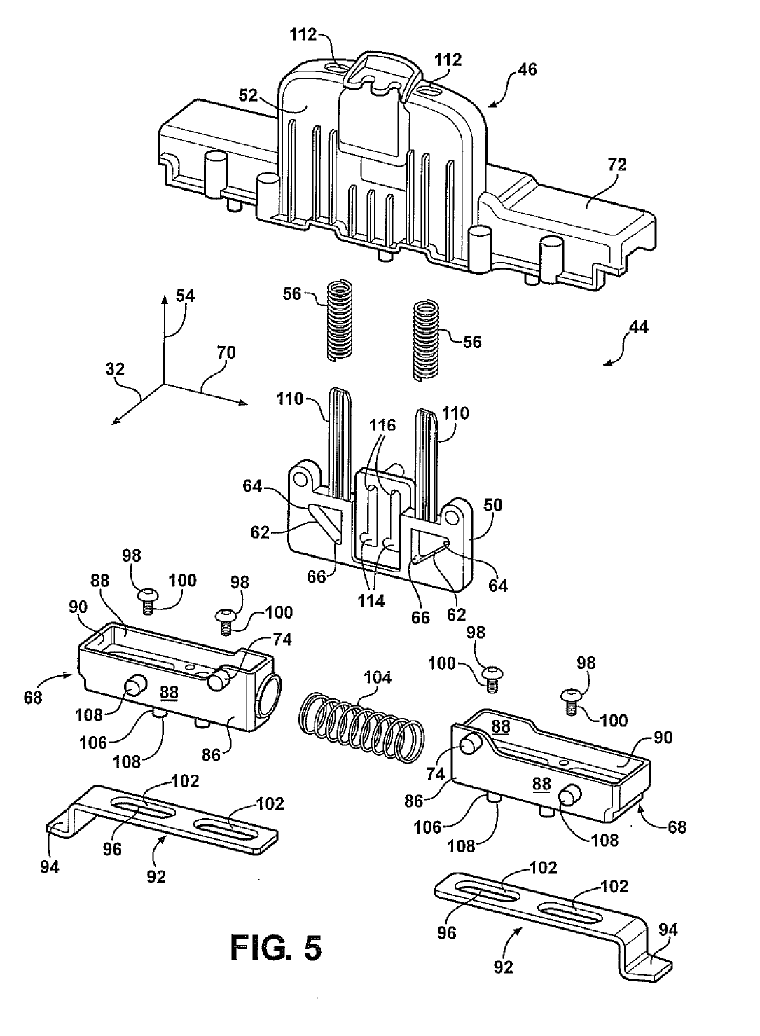

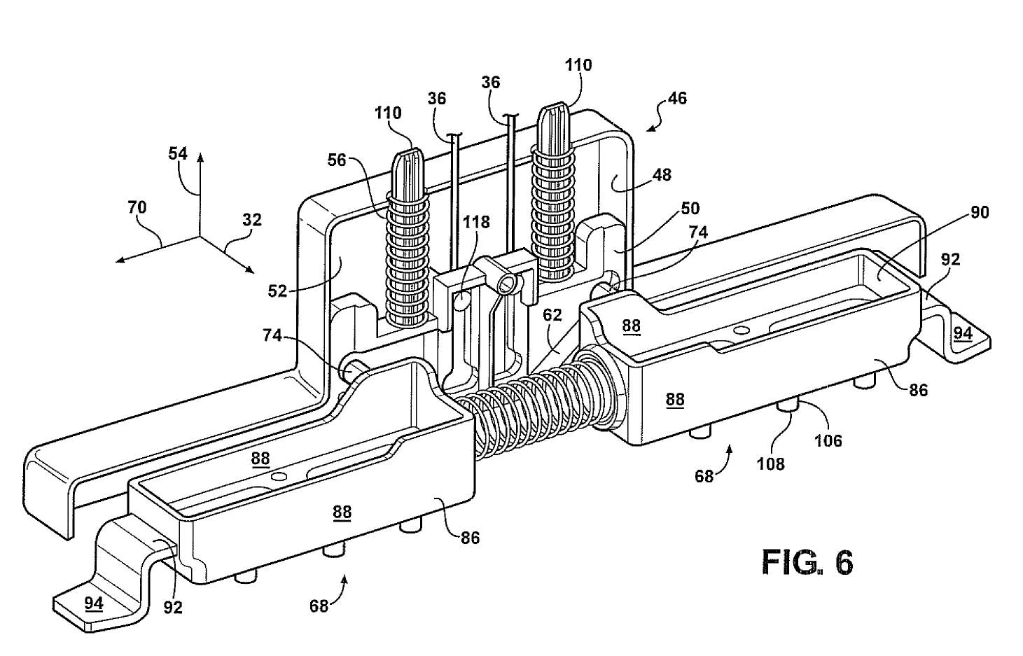

With reference now to FIGS. 5 and 6, the console assembly 10 further includes a lock assembly housing 46. The lock assembly housing 46 includes an inner wall surface 48. The lock assembly housing 46 is fixedly mounted to the slidable storage compartment 16 and is disposed between the pair of rails 30. The lock assembly housing 46 is configured to house the lock assembly 44 and control the movements of the components of the lock assembly 44 in a predetermined manner as described in more detail below. Preferably the lock assembly housing 46 is made of a polymer such as plastic, or other polymer composites currently known and used in the art.

The lock assembly 44 is mounted within the lock assembly housing 46. The lock assembly 44 includes a plate 50 slidably disposed within the lock assembly housing 46. The lock assembly housing 46 also includes a first chamber 52 configured to guide the plate 50 along the second longitudinal axis 54. The locking assembly further includes a first biasing member 56. The first biasing member 56 is disposed between the outer surface of the plate 50 and the inner wall surface 48 of the lock assembly housing 46. The plate 50 is slidably engaged with the inner wall surface 48 of the lock assembly housing 46 and slides along a second longitudinal axis 54 between a first position 58 and a second position 60. The second longitudinal axis 54 may be normal to the first longitudinal axis 32.

The plate 50 includes a pair of operative surfaces 62 spaced apart from each other. Each of the operative surfaces 62 is generally symmetrical to the other, and each of the pair operative surfaces 62 is disposed along an angle relative to the first longitudinal axis 32. Each operative surface 62 includes a first end 64 opposite a second end 66. The first ends 64 of each operative surface 62 are further away from each other than the second ends 66 of each of the operative surfaces 62. Each end of the second split end 40 is attached to the plate 50. Either handle 42 is operable to pull the cable 36 so as to overcome the biasing force of the first biasing member 56 and move the plate 50 along the first longitudinal axis 32 from the first position 58 to the second position 60.

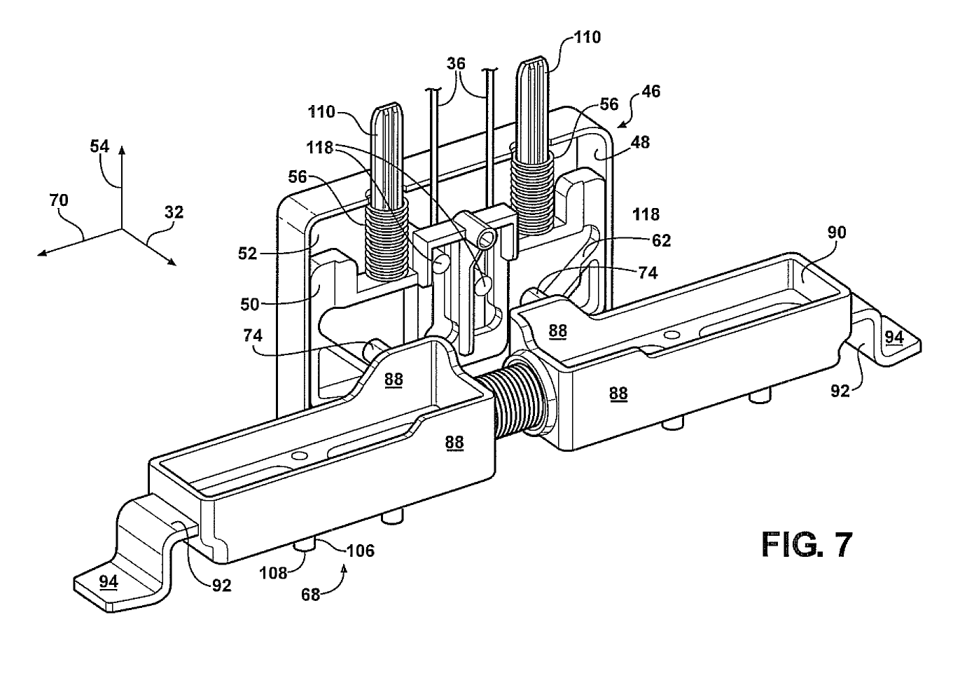

With reference now to FIGS. 6 and 7, the lock assembly 44 further includes a pair of retainers 68 slidably disposed within the lock assembly housing 46 along a third longitudinal axis 70. The third longitudinal axis 70 is generally normal to both the first and second longitudinal axes 32, 54. The lock assembly housing 46 further includes a second chamber 72. The second chamber 72 is in communication with the first chamber 52 and is configured so as to guide the retainers 68 along the third longitudinal axis 70. More specifically, the second chamber 72 is generally normal to the first chamber 52 so as to give the lock assembly housing 46 a generally “T” shaped body.

Each of the pair of retainers 68 includes a pin 74 configured to slidably engaged respective operative surfaces 62 of the plate 50. The pins 74 are fixedly mounted to the retainers 68 so as to place the retainers 68 in slidable engagement with a corresponding operative surface 62. As stated above, the first biasing member 56 is operatively connected to the plate 50. As shown in FIG. 6, the first biasing member 56 urges the plate 50 to the first position 58 so as to urge the pins 74 of both of the pair of retainers 68 to the first end 64 of the corresponding pair of operative surfaces 62. As the pins 74 slide towards the first end 64 of the operative surfaces 62, the retainers 68 are displaced further away from each other wherein the retainers 68 are placed into engagement with the pair of rails 30. Preferably, the retainers 68 and the plate 50 are made of a hardened polymer, or a polymer composite such as plastic.

With reference again to FIG. 7, actuation of either of the pair of handles 42 overcomes the force of the first biasing member 56 so as to urge the pins 74 of both of the pair of retainers 68 to the second end 66 of the corresponding pair of operative surfaces 62. As the pins 74 slide toward the second end 66 of the operative surfaces 62, each of the pair of retainers 68 are displaced towards each other so as to move into the second position 60. In the second position 60, the pair of retainers 68 are disengaged from the pair of rails 30 and the slidable storage compartment 16 may be slid to a desired position between the rails 30. Upon release of the actuated handle 42, the first biasing member 56 is operative to urge the plate 50 back into the first position 58 wherein the plate 50 is pushed towards the base 12. As the plate 50 moves towards the base 12, the pins 74 slide along the operative surfaces 62 to the first end 64 of the operative surfaces 62. As the pins 74 move towards the first end 64 of the operative surfaces 62, the retainers 68 are displaced further away from each other along the third longitudinal axis 70 so as to engage a corresponding rail slot 34 and fix the slidable storage compartment 16 between the rails 30.

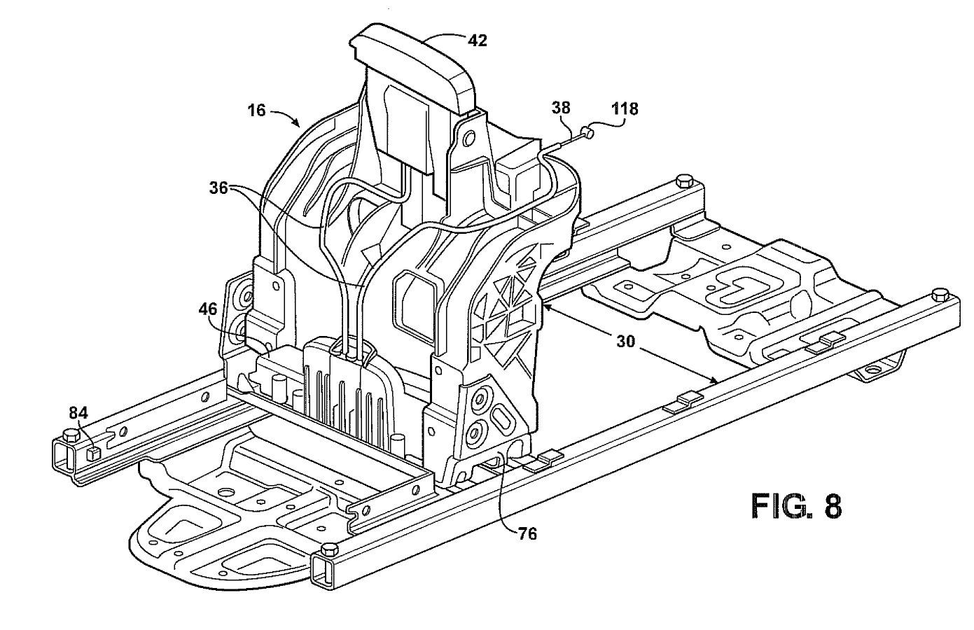

With reference now to FIG. 8, and again to FIGS. 6 and 7, a first preferred embodiment of the console assembly 10 is provided. In the first preferred embodiment, the console assembly 10 includes a pair of cables 36. One end of each of the pair of cables 36 is connected to a corresponding one of the pair of handles 42 and the other end of each of the pair cables 36 is connected to a corresponding one of the pair of retainers 68. Thus, each handle 42 is operable to engage and disengage the retainers 68 from the rail 30.

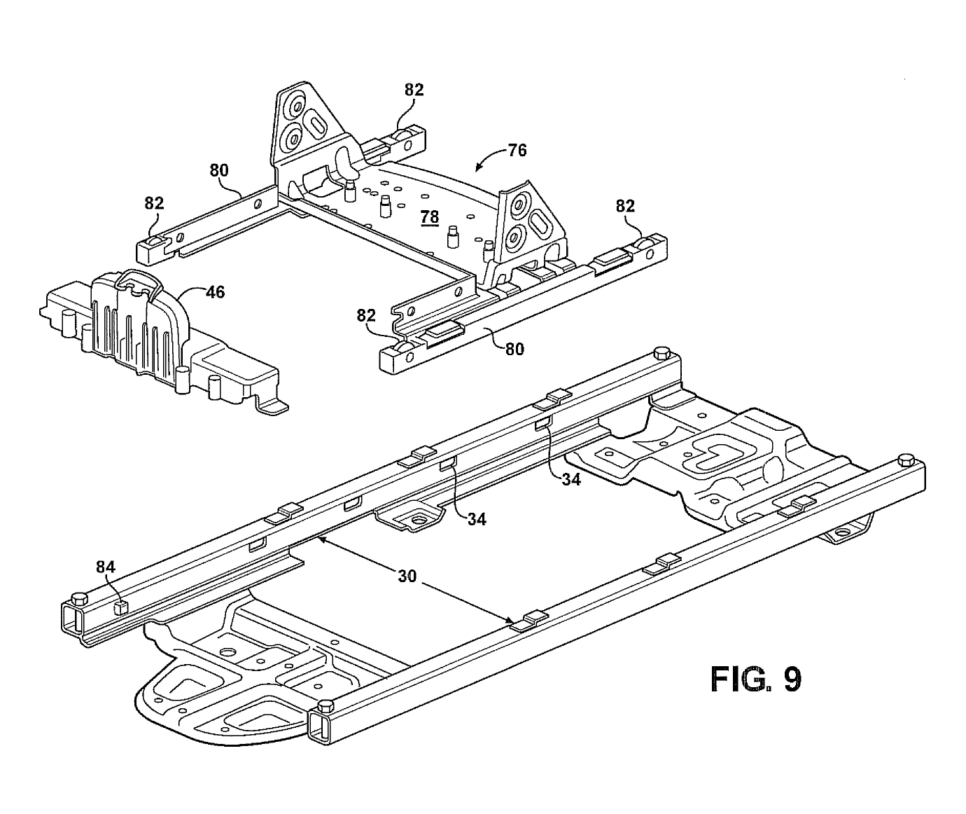

With reference now to FIG. 9, the console assembly 10 further includes a carriage 76 having a carriage floor 78, and a pair of opposing rigid supports 80. The carriage 76 is fixedly mounted to the slidable storage compartment 16 and slidably mounted to the base 12. The rigid supports 80 may be integrally formed along opposite sides of the carriage floor 78 of the carriage 76. The rigid supports 80 may be configured to rotatably hold a plurality of rollers 82. The rollers 82 are configured to roll along the rail 30 so as to position the retainers 68 into engagement with selected corresponding rail slots 34 of the rail 30. The lock assembly housing 46 is mounted onto the carriage floor 78. Thus, the carriage 76 provides support for the lock assembly housing 46. The rail 30 may further include an abutment 84. The abutment 84 extends outwardly from the outer surface of the rail 30 and is selectively disposed along the rail 30 so as to control the movement of the carriage 76 along the rail 30. Preferably the carriage 76 and rail 30 are stamped out of a durable material such as steel.

With reference again to FIG. 5, each of the pair of retainers 68 includes a retainer housing 86 slidably mounted within the lock assembly housing 46. Each retainer housing 86 has a pair of spaced apart opposing retainer walls 88. The pair of spaced apart opposing retainer walls 88 define a channel 90. The channel 90 runs along the third longitudinal axis 70. Preferably the retainer housing 86 is made from a hardened polymer such as plastic, or a polypropylene composite currently known or used in the art.

The retainers 68 further include an elongated member 92. The elongated members 92 are fixedly mounted between the pair of spaced apart opposing retainer walls 88 so as to extend along the channel 90 in the third longitudinal axis 70. Each of the elongated members 92 include an end portion 94 configured to engage a corresponding rail 30. More specifically, the end portions 94 of each elongated member 92 are fittingly received within a rail slot 34. The end portions 94 may be tapered so as to facilitate the engagement of the end portions 94 into the rail slot 34. Preferably the elongated members 92 are stamped out of metal.

Each of the elongated members 92 has a slotted portion 96 axially aligned along the elongated members 92 in the third longitudinal axis 70. The locking assembly further includes a stop 98 disposed within each of the slotted portions 96. The stops 98 are coaxially aligned with the slotted portions 96. The stops 98 are fixedly mounted to the floor of the carriage 76 and include an outer stop surface 100. The outer stop surface 100 is spaced apart from an inner peripheral edge 102 of the slotted portion 96 so as to account for manufacturing tolerances. The stops 98 are selectively mounted within the inner peripheral edge 102 of the respective slotted portion 96. The stops 98 provide support for the lock assembly 44 so as to help prevent the locking assembly from being disengaged from the carriage 76 when experiencing a load. Preferably the stops 98 and the elongated members 92 are formed of a durable material such as steel.

The console assembly 10 further includes a second biasing member 104. The second biasing member 104 is disposed between each of the pair of retainers 68 so as to interconnect one of the pair of retainers 68 to the other of the pair of retainers 68. The second biasing member 104 is operable to urge the pair of retainers 68 away from each other. As the retainers 68 are urged away from each other, the pins 74 of each of the retainers 68 are slid along the operative surfaces 62 towards the first end 64 of the operative surfaces 62 so as to move the pair of retainers 68 into the first position 58. However, actuation of either of the handles 42 moves the pins 74 towards the second end 66 of the operative surface 62 so as to overcome the force of the second biasing member 104 and bring the retainers 68 closer towards the second position 60. As stated above, in the second position 60 the end portions 94 of the elongated members 92 are disengaged from respective rails 30. Thus the slidable storage compartment 16 may be slid to a desired position along the base 12.

The retainer housing 86 further includes a plurality of raised portions 106 selectively disposed along the outer surface of the retainer housing 86. Each of the plurality of raised portions 106 includes a slide surface 108. The slide surface 108 is configured to be in sliding engagement with the inner wall surface 48 of the lock assembly housing 46 so as to help control the movement of the retainers 68 along the third longitudinal axis 70.

The plate 50 may further include a pair of elongated supports 110, and the lock assembly housing 46 may further include a pair of apertures 112. Each aperture 112 is configured to receive a portion of the elongated support 110. The lock assembly 44 may further include a pair of first biasing members 56. One of the pair of first biasing members 56 is mounted onto one of the pair of elongated supports 110, and the other of the pair of first biasing members 56 is mounted onto the other of the pair of elongated supports 110. The elongated members 92 are then placed within respective apertures 112 so as to place the first biasing members 56 in communication with the outer surface of the plate 50 and the inner wall surface 48 of the lock assembly housing 46. The first biasing members 56 urge the plate 50 along the second longitudinal axis 54 towards the base 12. The elongated supports 110 help guide and control the movement of the plate 50 along the second longitudinal axis 54. Though the Figures show the console assembly 10 having two elongated members 92, it is anticipated that any number of configurations are possible. For instance, the plate 50 may have just one elongated member 92 extending between the cables 36. In such an embodiment, the lock assembly housing 46 has just one aperture 112 and the console assembly 10 has only one first biasing member 56. The lone first biasing member 56 is mounted onto the lone elongated support 110 and operates in the same manner as described above.

The plate 50 may further include a pair of elongated slots 114, each of the pair of elongated slots 114 is spaced apart from the other and extends along the second longitudinal axis 54. Each elongated slot 114 may include a catch portion 116 disposed on the upper end. Each of the pair of cables 36 may further include a head portion 118 configured to slidingly engage a corresponding elongated slot 114. The head portion 118 is fixedly mounted to the free end of each one of the pair of cables 36. Actuation of either of the pair of handles 42 slides the head portion 118 along the elongated slot 114 to the catch portion 116 wherein the head portion 118 urges the plate 50 along the second longitudinal axis 54 away from the base 12. Thus as shown in FIG. 7, actuation of one of the pair of handles 42 does not affect the other. More specifically, the cable 36 of the handle 42 that is not being actuated simply rests within the elongated slot 114 as the actuated handle 42 urges the plate 50 into the second position 60.

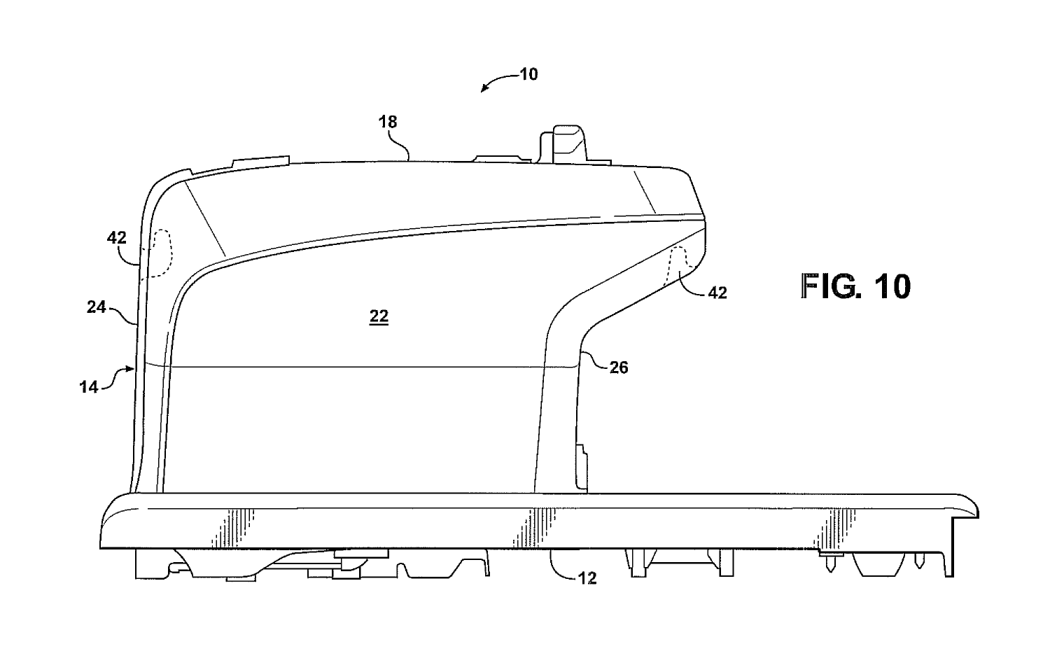

With reference now to FIG. 10, another embodiment of the sliding console is provided. In this embodiment, the handles 42 are positioned on opposite ends of the bin 14, and the entire bin 14 is slidable between a forward and a rear position. In the forward position, the bin 14 is substantially displaced between the driver and front passenger seats, and in the rear position, the bin 14 is substantially displaced behind the driver and front passenger seats. Thus in the forward position the bin 14 is easily accessible by either the driver or the front passenger of the vehicle. In the rear position, the bin 14 is easily accessible by the rear passengers. Additionally, the lock assembly housing 46 is configured so as to slide the plate 50 along the first longitudinal axis 32. Thus the first chamber 52 lies along the plane of the first longitudinal axis 32.

Obviously, many modifications and variations of the present invention are possible in light of the above teachings and may be practiced otherwise than as specifically described while within the scope of the appended claims.

What is claimed is:

1. A lock assembly for use with a bin, the bin having a pair of spaced apart handles and a cable, wherein the cable includes a first split end, and wherein one end of the first split end is attached to one of the pair of spaced apart handles, and the other end of the first split end is attached to the other of the pair of spaced apart handles, and wherein the other end of the cable is attached to the lock assembly, the lock assembly comprising:
a lock assembly housing having an inner wall surface, the lock assembly housing fixedly mounted to the bin and disposed between the pair of rails;
a plate slidably disposed within the lock assembly housing along a second longitudinal axis, wherein the other end of the cable is fixedly attached to the plate, wherein the plate is slidable along the second longitudinal axis between a first position and a second position, wherein the plate includes a pair of operative surfaces spaced apart from each other, wherein each of the pair of operative surfaces is generally symmetrical to the other, and wherein each of the pair operative surfaces is disposed along an angle relative to the second longitudinal axis, and wherein each of the operative surfaces includes a first end and a second end, wherein the first ends of each of the operative surfaces are closer to each other than the second ends of each of the operative surfaces;
a pair of retainers slidably disposed within the lock assembly housing along a third longitudinal axis between a first position and a second position, wherein in the first position the retainers are placed into engagement with the pair of rails and in the second position the retainers are disengaged from the pair of rails, and wherein the third longitudinal axis is generally normal to the second longitudinal axis, and wherein each of the pair of retainers includes a pin slidably engaged with a corresponding operative surface of the plate; and
a first biasing member, disposed between the plate and the inner wall surface of the lock assembly housing so as to urge the pins to the first end of the corresponding pair of operative surfaces, wherein each of the pair of retainers are displaced away from the other and moved into the first position, and wherein actuation of either of the pair of handles overcomes the force of the first biasing member so as to urge the pins to the second end of the corresponding pair of operative surfaces, wherein each of the pair of retainers are displaced towards the other and moved into the second position.

2. A console assembly for use in an automotive vehicle, the console assembly slidable between a forward and a rear position, the console assembly comprising:
a base having a first longitudinal axis and a pair of rails, each of the pair of rails spaced apart and parallel to the other, and wherein the pair of rails extend along the first longitudinal axis of the base;
a bin having a pair of opposing side walls, and a front wall opposite a rear wall, the bin slidably mounted onto the base;
a pair of handles mounted on opposite ends of the bin;
a cable having a first split end and a second split end, wherein each end of the first split end of the cable is operatively connected to a corresponding handle of the pair of handles;
a lock assembly housing having an inner wall surface, the lock assembly housing fixedly mounted to the bin and disposed between the pair of rails; and
a lock assembly mounted within the lock assembly housing, the lock assembly having a plate slidably disposed within the lock assembly housing along a second longitudinal axis, wherein each end of the second split end is attached to a the plate;
a pair of retainers slidably disposed within the lock assembly housing along a third longitudinal axis, and a first biasing member, wherein the second longitudinal axis is normal to the first longitudinal axis, and wherein the third longitudinal axis is generally normal to both the first and second longitudinal axes and wherein the plate is slidable along the second longitudinal axis between a first position and a second position, wherein the plate includes a pair of operative surfaces spaced apart from each other, wherein each of operative surfaces is generally symmetrical to the other, and wherein each of the pair operative surfaces is disposed along an angle relative to the first axis; and
wherein each of the pair of retainers includes a pin configured to slidably engaged the operative surface, and wherein each pin of the pair of retainers is slidably engaged with a corresponding operative surface; and
wherein the first biasing member is operatively connected to the plate so as to urge the pins of both of the pair of retainers to one end of the corresponding pair of operative surfaces and displace each of the pair of retainers away from each other and into the first position wherein the retainers are placed into engagement with the pair of rails, and wherein actuation of either of the pair of handles overcomes the force of the first biasing member so as to urge the pins of both of the pair of retainer to the other end of the corresponding pair of operative surfaces, wherein each of the pair of retainers are displaced towards each other and into the second position wherein the pair of retainers are disengaged from the pair of rails.

3. The lock assembly as set forth in claim 2, further including a pair of cables, wherein one end of each of the pair of cables is connected to a corresponding one of the pair of handles and the other end of each of the pair cables is connected to the plate.

4. The console assembly as set forth in claim 2, further including a carriage having a carriage floor, wherein the carriage is slidably mounted between the pair of rails and fixedly attached to the bin, and wherein the lock assembly housing is mounted onto the carriage floor.

5. The console assembly as set forth in claim 2, wherein each of the pair of retainers includes a retainer housing slidably mounted within the lock assembly housing, the retainer housing having a pair of spaced apart opposing retainer walls, wherein the pair of spaced apart opposing retainer walls define a channel, wherein the channel runs along the third longitudinal axis, and wherein each rail includes a plurality of rail slots;
an elongated member fixedly mounted between the pair of spaced apart opposing retainer walls, the elongated member including an end portion configured to engage a corresponding rail slot; and
a second biasing member interconnecting the one of the pair of retainers to the other of the pair of retainers, and wherein the second biasing member is operable to urge the pair of retainers away from each other so as to urge the both of the pair of retainers to slide along the operative surfaces and move the pair of retainers into the first position.

6. The console assembly as set forth in claim 5, wherein both elongated members further include a slotted portion axially aligned along the third longitudinal axis of the elongated members.

7. The console assembly as set forth in claim 6, further including a stop disposed within each of the slotted portions, wherein the stop is fixedly mounted to the carriage floor and includes an outer stop surface, the outer stop surface spaced apart from the inner peripheral edge of the slotted portion, and wherein the slotted portions and the stops are coaxially aligned with each other.

8. The console assembly as set forth in claim 2, wherein the retainer housing include a plurality of raised portions selectively disposed along the outer surface of the retainer housing, wherein each of the plurality of raised portions includes a slide surface, wherein the slide surface is in sliding engagement with the inner wall surface of the lock assembly housing so as to help control the movement of the retainers along the third longitudinal axis.

9. The console assembly as set forth in claim 2, wherein the plate includes an elongated support, and wherein the lock assembly housing includes an aperture configured to receive a portion of the elongated support, and wherein the first biasing member is mounted onto the support so as to urge the plate along the second longitudinal axis towards the base.

10. The console assembly as set forth in claim 2, wherein the plate further includes a pair of elongated slots, each of the pair of elongated slots extending along the second longitudinal axis.

11. The console assembly as set forth in claim 10, wherein the each of the pair of cables includes a head portion configured to slidingly engage a corresponding elongated slot, the head portion having a catch portion disposed on one end of the elongated slot, wherein the head portion is fixedly mounted to the free end of each one of the pair of cables, and wherein actuation of either of the pair of handles slides the head portion along the elongated slot to the catch portion wherein the head portion urges the plate along the second longitudinal axis away from the base.

12. The console assembly as set forth in claim 2 wherein the plate includes a pair of elongated supports and a pair of first biasing members, each of the pair of elongated supports spaced apart from the other, and wherein the lock assembly housing includes a pair of apertures, each of the pair of apertures is configured to receive a corresponding elongated member, and wherein one of the pair of first biasing members is mounted onto one of the pair of elongated supports and the other of the pair of first biasing members is mounted onto the other of the pair of elongated supports, wherein both of the pair of biasing members are disposed between the outer surface of the plate and the inner wall surface of the lock assembly housing so as to urge the plate along the second longitudinal axis towards the base.

13. The console assembly as set forth in claim 2, further including a slidable storage compartment, and wherein the wherein the bin is fixedly secured to the base and includes an opening disposed one of either the front wall or rear wall, and wherein the opening is configured to receive the storage compartment, and wherein one of the pair of handles is mounted on one end of the storage compartment, and the other of the pair of handles is mounted onto the other end of the storage compartment, and wherein the lock assembly housing is fixed to the storage compartment, and wherein the storage compartment is fixedly mounted to the floor of the carriage.

14. The console assembly as set forth in claim 2, wherein the lock assembly housing is configured so as to slide the plate along the first longitudinal axis.

15. A lock assembly operable to selectively fix a bin between a pair of rails, the bin having a pair of spaced apart handles, wherein each handle includes a cable operatively connecting each handle to the lock assembly, the lock assembly comprising:
a lock assembly housing fixedly mounted to the bin, the lock assembly housing having inner wall surfaces so as to define a first chamber and a second chamber, wherein the first chamber extends along a second longitudinal axis and the second chamber extends along a third longitudinal axis wherein the third longitudinal axis is generally normal to the second longitudinal axis;
a plate slidably disposed within the first chamber along the second longitudinal axis and operatively connected to each of cable, wherein actuation of either of the pair of handles is operative to slide the plate along the second longitudinal axis between a first position and a second position, wherein the plate includes a pair of operative surfaces spaced apart from and generally symmetrical to each other, and wherein each of the pair operative surfaces is disposed along an angle relative to the second longitudinal axis, and wherein each of the operative surfaces includes a first end and a second end, wherein the first ends of each of the operative surfaces are closer to each other than the second ends of each of the operative surfaces;
a pair of retainers slidably disposed within the second chamber along the third longitudinal axis between a first position and a second position, wherein in the first position the retainers are placed into engagement with the pair of rails and in the second position the retainers are disengaged from the pair of rails, and wherein each of the pair of retainers includes a pin slidably engaged with a corresponding operative surface of the plate; and
a first biasing member, disposed in the first chamber between the plate and the inner wall surface of the lock assembly housing so as to urge plate away from a portion of the inner wall surface of the first chamber and move the pins to the first end of the corresponding pair of operative surfaces, wherein each of the pair of retainers are displaced away from the other and moved into the first position, and wherein actuation of either of the pair of handles overcomes the force of the first biasing member so as to urge the pins to the second end of the corresponding pair of operative surfaces, wherein each of the pair of retainers are displaced towards the other and moved into the second position.
